(19) United States
(12) Patent Application Publication
(10) Pub. No.: US 2025/0320327 A1
(43) Pub. Date: Oct. 16, 2025

(54) HIGH TEMPERATURE STABLE SANDWICH PANELS

(71) Applicant: Huntsman International LLC, The Woodlands, TX (US)

(72) Inventors: Norman Chi Su, Auburn Hills, MI (US); John Connolly, Auburn Hills, MI (US)

(21) Appl. No.: 18/862,972

(22) PCT Filed: Apr. 19, 2023
(86) PCT No.: PCT/US2023/019050

§ 371 Date: Nov. 5, 2024

Related U.S. Application Data
(60) Provisional application No. 63/340,210, filed on May 10, 2022.

(51) Int. Cl. C08G 18/66; B29C 44/12; B29K 75/00; B29K 105/04; B29L 31/30; C08G 18/32; C08G 18/48; C08G 18/76; C08G 18/79; C08J 5/24

(52) U.S. Cl. CPC C08G 18/6677; B29C 44/1266; C08G 18/3206; C08G 18/4829; C08G 18/7671; C08G 18/797; C08J 5/247; B29K 2075/00; B29K 2105/04; B29L 2031/3005; C08G 2110/0083; C08J 2375/08

(57) ABSTRACT

The present disclosure provides a reaction mixture for producing polyurethane/polyisocyanurate sandwich panels having a high temperature stability of up to about 230 Deg C. The polyurethane/polyisocyanurate sandwich panels may be used in connection with the production of automotive structural parts. The present disclosure also provides a process for the production of a polyurethane/polyisocyanurate molded article which exhibits high temperature stability.

### CROSS REFERENCE TO RELATED APPLICATIONS

This application claims the benefit of U.S. Provisional Patent Application Ser. No. 63/340,210, filed May 10, 2022, the entire contents of which are expressly incorporated herein by reference.

### STATEMENT REGARDING FEDERALLY SPONSORED RESEARCH OR DEVELOPMENT

Not applicable.

### FIELD

The present disclosure generally relates to a reaction mixture for producing polyurethane/polyisocyanurate sandwich panels, a process for producing polyurethane/polyisocyanurate sandwich panels, and to structures including the polyurethane/polyisocyanurate sandwich panels which may be used in various applications, including, but not limited to, automotive applications.

### BACKGROUND

Because of their light weight and stiffness, polyurethane-based sandwich panels have seen widespread adoption for use in automotive applications. These sandwich panels generally include a core made from a thermoset or thermoplastic foam or a honeycomb/cylindrical structure-like paper, thermoplastic, or metal that is positioned between two skin layers made from a fiber reinforced polymer. The fiber reinforcement can take the form of glass, carbon, natural or polymeric fiber mat in chopped, continuous, stitched, or needled form. A polyurethane-forming reaction mixture is applied to at least one side of the semi-finished sandwich panel, preferably via spray-application. The semi-finished sandwich panel is then placed into a mold and given a particular shape by compression in a thermal compression process to harden the polyurethane reaction mixture.

One drawback to current polyurethane-based sandwich panels is that they are not capable of withstanding exposure to high temperatures and have therefore been limited for use in the production of automotive load floors. In particular, when exposed to high temperatures, the polyurethane-based sandwich panel can exhibit defects as evidenced by irreversible swelling or surface blistering in resin rich areas.

There is a need to improve upon current polyurethane-based sandwich panels so that they are capable of being used in the production of other semi-structural automotive parts exposed to high temperatures, such as roof modules, hoods, side panels and liftgates.

### SUMMARY

The present disclosure describes a reaction mixture for use in the production of polyurethane/polyisocyanurate sandwich panels which exhibit high temperature stability, the reaction mixture comprising: (i) a polyol; (ii) a polyisocyanate; (iii) a catalyst, (iv) a blowing agent; and optionally (v) at least one chain extender or crosslinking agent and optionally (vi) an additive and where the reaction mixture has an isocyanate index greater than 200.

Also provided is a process for the production of a polyurethane/polyisocyanurate molded article which exhibits high temperature stability, including the steps of:
a) applying a first fiber material having a first surface and a second surface to a first surface of a core material;
b) applying a second fiber material having a first surface and a second surface to a second surface of the core material forming a sandwich structure having a first and a second surface wherein the first and second fiber material may be the same of different;
c) applying the reaction mixture of claim 1 to the first and the second surface of the sandwich structure forming a reaction mixture coated sandwich structure;
d) placing the reaction mixture coated sandwich structure into a mold;
e) shaping the reaction mixture coated sandwich structure in the mold at a temperature within a range of about 100° C. and about 160° C. while curing the reaction mixture to form the polyurethane/polyisocyanurate molded article;
f) removing the polyurethane/polyisocyanurate molded article from the mold; and
e) optionally, post-treating the polyurethane/polyisocyanurate molded article.

### BRIEF DESCRIPTION OF THE DRAWINGS

FIG. 1A is an illustration of a process of the present disclosure;

FIG. 1B is a magnified view the sandwich structure of the process shown in FIG. 1A; and

FIG. 1C is a magnified view of the molded article of the process shown in FIG. 1A.

### DETAILED DESCRIPTION

The present disclosure provides a reaction mixture for use in the production of polyurethane/polyisocyanurate sandwich panels which exhibit high temperature stability, the reaction mixture including: (i) a polyol; (ii) a polyisocyanate; (iii) a catalyst, (iv) a blowing agent; and optionally (v) at least one chain extender or crosslinking agent and optionally (vi) an additive and where the reaction mixture has an isocyanate index greater than 200. Through a combination of changes to state of the art reaction mixtures used in the production of rigid foam, including changes to the components of the reaction mixture and increasing the isocyanate index as well as optimizing mold temperatures, polyurethane/polyisocyanurate sandwich panels can be molded within current processing windows and achieve high-temperature stability of up to about 210° C., or in other embodiments up to about 230° C. (i.e. does not exhibit thermal and dimensional instability after exposure to a temperature of up to about 210° C., or up to about 230° C., for an extended period of time). Accordingly, such panels can now be effectively used in connection with the production of various automotive structural parts, including, but not limited to, roofs, hoods, door panels, liftgates, and floors, during in-line main assembly of a vehicle.

If appearing herein, the term “comprising” and derivatives thereof are not intended to exclude the presence of any additional component, step, or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step, or procedure, except those that are not essential to operability and the term “consisting of”, if used, excludes any component, step or procedure not specifically delineated or listed. The terms “or” and “and/or”, unless stated otherwise, refer to the listed members individually as well as in any combination. For example, the expression A and/or B refers to A alone, B alone, or to both A and B.

The articles “a” and “an” are used herein to refer to one or to more than one (i.e., to at least one) of the grammatical objects of the article. By way of example, “a polyol” means one polyol or more than one polyol. The phrases “in one embodiment”, “according to one embodiment” and the like generally mean the feature, structure, or characteristic following the phrase is included in at least one embodiment of the present disclosure and may be included in more than one embodiment of the present disclosure. Importantly, such phrases do not necessarily refer to the same embodiment. If the specification states a component or feature “may”, “can”, “could”, or “might” be included or have a characteristic, that component or feature is not required to be included or have the characteristic.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “optional” or “optionally” means that the subsequently described event or circumstance may or may not occur, and that the description includes instances where said event or circumstance occurs and instances where it does not.

The term “extended period of time” as used herein refers to any period of time that would be considered by those of ordinary skill in the art as being extended with respect to the assembly of a structure using molded parts, such as a vehicle, and in particular refers to periods such as at least about 5 minutes or at least about 10 minutes or at least about 15 minutes or at least about 30 minutes.

“Isocyanate index” or “NCO index” or “index” refers to the ratio of NCO-groups over isocyanate-reactive hydrogen atoms present in a formulation, given as a percentage: [NCO]×100/[active hydrogen] (%).

The term “hydroxyl value” refers to the concentration of hydroxyl groups, per unit weight of the polyol, that can react with —NCO groups. The hydroxyl number is reported as mg KOH/g and may be measured according to the standard ASTM D 1638.

The term “average functionality”, or “average hydroxyl functionality” of a polyol indicates the number of OH groups per molecule, on average. The average functionality of an isocyanate refers to the number of —NCO groups per molecule, on average.

The term “reaction mixture”, as used herein, may be used when two or more components of the mixture have been combined, or to refer to all components of the mixture prior to their having been combined, and does not necessarily require that all components are present at all times simultaneously.

The term “substantially free” refers to a composition in which a particular constituent or moiety is present in an amount that has no material effect on the overall composition. In some embodiments, “substantially free” may refer to a composition in which the particular constituent or moiety is present in the composition in an amount of less than about 5 wt. %, or less than about 4 wt. %, or less than about 3 wt. % or less than about 2 wt. % or less than about 1 wt. %, or less than about 0.5 wt. %, or less than about 0.1 wt. %, or less than about 0.05 wt. %, or even less than about 0.01 wt. % based on the total weight of the composition, or that no amount of that particular constituent or moiety is present in the respective composition.

Accordingly, the present disclosure provides a reaction mixture for producing polyurethane/polyisocyanurate sandwich panels which exhibit high temperature stability up to about 210° C., or in some embodiments up to about 230° C. In one embodiment, the reaction mixture includes (i) a polyol having at least two isocyanate reactive moieties per compound. For example, the polyol or mixtures thereof may be liquid at 25° C., have a molecular weight ranging from 60 Daltons to 10,000 Daltons (e.g., 300 Daltons to 10,000 Daltons or less than 5,000 Daltons), a nominal hydroxyl functionality of at least 2, and a hydroxyl equivalent weight of 30 to 2000 (e.g., 30 to 1,500 or 30 to 800). Examples of polyols that may be used include polyether polyols, such as those made by addition of alkylene oxides to initiators, containing from 2 to 8 active hydrogen atoms per compound. In some embodiments, the aforementioned initiators include glycols, glycerol, trimethylolpropane, triethanolamine, pentaerythritol, sorbitol, sucrose, ethylenediamine, ethanolamine, diethanolamine, aniline, toluenediamines (e.g., 2,4 and 2,6 toluenediamines), polymethylene polyphenylene polyamines, N-alkylphenylene-diamines, o-chloro-aniline, p-aminoaniline, diaminonaphthalene, or combinations thereof. Suitable alkylene oxides that may be used to form the polyether polyols include ethylene oxide, propylene oxide, and butylene oxide, or combinations.

Other suitable polyols include Mannich polyols having a nominal hydroxyl functionality of at least 2 and at least one secondary or tertiary amine nitrogen atom per molecule. In some embodiments, Mannich polyols are the condensates of an aromatic compound, an aldehyde, and an alkanol amine. For example, a Mannich condensate may be produced by the condensation of either or both of phenol and an alkylphenol with formaldehyde and one or more of monoethanolamine, diethanolamine, and diisopronolamine. In some embodiments, the Mannich condensates comprise the reaction products of phenol or nonylphenol with formaldehyde and diethanolamine. The Mannich condensates may be made by any known process. In some embodiments, the Mannich condensates may serve as initiators for alkoxylation. Any alkylene oxide (e.g., those alkylene oxides mentioned above) may be used for alkoxylating one or more Mannich condensates. When polymerization is completed, the Mannich polyol comprises primary hydroxyl groups and/or secondary hydroxyl groups bound to aliphatic carbon atoms.

In certain embodiments, the polyols that are used are polyether polyols that comprise propylene oxide (“PO”), ethylene oxide (“EO”), or a combination of PO and EO groups or moieties in the polymeric structure of the polyols. These PO and EO units may be arranged randomly or in block sections throughout the polymeric structure. In certain embodiments, the EO content of the polyol ranges from 0% to 100% by weight, based on the total weight of the polyol (for e.g., 0% to about 50% by weight, or about 50% to 100% by weight, based on the total weight of the polyol). In some embodiments, the PO content of the polyol ranges from 100% to 0% by weight based on the total weight of the polyol (for e.g., 100% to about 50% by weight or about 50% to 0% by weight, based on the total weight of the polyol). Accordingly, in some embodiments, the EO content of a polyol can range from about 99% to about 33% by weight of the polyol while the PO content can range from about 1% to 67% by weight of the polyol. In other embodiments, the PO content of the polyol can range from about 99% to about 33% by weight and the EO content can range from about 1% to about 67% by weight of the polyol. Moreover, in some embodiments, the EO and/or PO units can either be located terminally on the polymeric structure of the polyol or within the interior sections of the polymeric backbone structure of the polyol. Suitable polyether polyols include poly(oxyethylene) diols and triols obtained by the addition of ethylene oxide to di- or tri-functional initiators known in the art, poly(oxyproplylene) diols and triols obtained by the addition of propylene oxide to di- or tri-functional initiators known in the art, and poly(oxyethylene) and poly(oxypropylene) diols and triols obtained by the sequential addition of propylene and ethylene oxides to di- or trifunctional initiators that are known in the art. In certain embodiments, the polyol comprises the aforementioned diols or alone or, alternatively, the polyol comprises a mixture of these diols and triols.

The aforementioned polyether polyols also include the reaction products obtained by the polymerization of ethylene oxide with another cyclic oxide (e.g., propylene oxide) in the presence of polyfunctional initiators such as water and low molecular weight polyols. Suitable low molecular weight polyols include ethylene glycol, propylene glycol, diethylene glycol, dipropylene glycol, cyclohexane dimethanol, resorcinol, bisphenol A, glycerol, trimethylolopropane, 1,2,6-hexantriol, pentaerythritol, or combinations thereof.

In another embodiment, the polyol may include a polyester polyol. The polyester polyol includes polyesters having a linear polymeric structure and a number average molecular weight ranging from about 500 Daltons to about 10,000 Daltons (e.g., preferably from about 700 Daltons to about 5,000 Daltons or about 700 Daltons to about 4,000 Daltons) and an acid number generally less than 1.3 (e.g., less than 0.8). The molecular weight is determined by assay of the terminal functional groups and is related to the number average molecular weight. The polyester polymers can be produced using techniques known in the art such as: (1) an esterification reaction of one or more glycols with one or more dicarboxylic acids or anhydrides; or (2) a transesterification reaction (i.e., the reaction of one or more glycols with esters of dicarboxylic acids). Mole ratios generally in excess of more than one mole of glycol to acid are preferred so as to obtain linear polymeric chains having terminal hydroxyl groups. Suitable polyester polyols also include various lactones that are typically made from caprolactone and a bifunctional initiator such as diethylene glycol. The dicarboxylic acids of the desired polyester can be aliphatic, cycloaliphatic, aromatic, or combinations thereof. Suitable dicarboxylic acids which can be used alone or in mixtures generally have a total of from 4 to 15 carbon atoms include succinic, glutaric, adipic, pimelic, suberic, azelaic, sebacic, dodecanedioic, isophthalic, terephthalic, cyclohexane dicarboxylic, or combinations thereof. Anhydrides of the aforementioned dicarboxylic acids (e.g., phthalic anhydride, tetrahydrophthalic anhydride, or combinations thereof) can also be used. In some embodiments, adipic acid is the preferred acid. The glycols used to form suitable polyester polyols can include aliphatic and aromatic glycols having a total of from 2 to 12 carbon atoms. Examples of such glycols include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, or combinations thereof.

Further examples of suitable polyols include hydroxyl-terminated polythioethers, polyamides, polyesteramides, polycarbonates, polyacetals, polyolefins, and polysiloxanes, In some embodiments, the polyol may be combined with another isocyanate reactive material such as, without limitation, a polyamine or polythiol. Suitable polyamines include primary and secondary amine-terminated polyethers, aromatic diamines such as diethyltoluene diamine, aromatic polyamines, and combinations thereof.

In one embodiment, the amount of the polyol present in the reaction mixture is at least about 50% by weight or at least about 60% by weight or at least about 70% by weight or at least about 80% by weight, based on the total weight of components (i), (iii), (iv), (v) and (vi) above. In other embodiments the amount of polyol present in the reaction mixture is within a range of about 50% by weight to 95% by weight, or about 55% by weigh to about 90% by weight, or about 60% by weight to about 85% by weight, based on the total weight of components (i), (iii), (iv), (v) and (vi). In yet another embodiment, the amount of polyol present in the reaction is less than 50% by weight, or less than about 45% by weight or less than about 40% by weight, based on the total weight of components (i), (iii), (iv), (v) and (vi) above.

The reaction mixture also includes (ii) a polyisocyanate. The polyisocyanate may be: (1) a diphenylmethane diisocyanate comprising at least 40%, preferably at least 50% or at least 60% and most preferably at least 85% by weight of 4,4′-diphenylmethane diisocyanate (4,4′-MDI); (2) a carbodiimide and/or uretonimine modified variant of diphenylmethane diisocyanate (1) having an NCO value of 20% by weight or more; (3) a urethane modified variant of diphenylene diisocyanate (1) having an NCO value of 20% by weight or more and being the reaction product of an excess of diphenylmethane diisocyanate (1) and of a polyol having an average nominal hydroxyl functionality of 2-4 and an average molecular weight of at most 1000; (4) a prepolymer having an NCO value of 20% by weight or more and which is the reaction product of an excess of any of the aforementioned polyisocyanates (1) to (3) and of a polyol having an average nominal hydroxyl functionality of 2-6, an average molecular weight of 2000-12000 and preferably a hydroxyl value of 15-60 mg KOH/g such as petroleum-based polyester polyols and polyether polyols and especially from polyoxyethylene polyoxypropylene polyols having an average nominal hydroxyl functionality of 2-4, an average molecular weight of 2500-8000, and preferably a hydroxyl value of 15-60 mg KOH/g and preferably either an oxyethylene content of 5-25% by weight, which oxyethylene preferably is at the end of the polymer chains, or an oxyethylene content of 50-90% by weight, which oxyethylene preferably is randomly distributed over the polymer chains, (5) polymeric MDI (e.g., MDI comprising 30% to 80% w/w 4,4′-MDI and the remainder of the MDI comprising MDI oligomers and MDI homologues), (6) 2,4-MDI or (7) a mixture of any of the aforementioned polyisocyanates. In some embodiments, the polyisocyanates (1) and (2) and mixtures thereof may be preferred as the polyisocyanate.

In other embodiments, the polyisocyanate may be toluene diisocyanate (“TDI”) (for e.g., 2,4 TDI, 2,6 TDI, or combinations thereof), hexamethylene diisocyanate (“HMDI” or “HDI”), isophorone diisocyanate (“IPDI”), butylene diisocyanate, trimethylhexamethylene diisocyanate, di(isocyanatocyclohexyl) methane (for e.g. 4,4′-diisocyanatodicyclohexylmethane), isocyanatomethyl-1,8-octane diisocyanate, tetramethylxylene diisocyanate (“TMXDI”), 1,5-naphtalenediisocyanate (“NDP”), p-phenylenediisocyanate (“PPDI”), 1,4-cyclohexanediisocyanate (“CDI”), tolidine diisocyanate (“TODI”), or combinations thereof.

A mixture of polyisocyanates may be produced in accordance with any technique known in the art. The isomer content of the diphenylmethane diisocyanate may be brought within the required ranges, if necessary, by techniques that are well known in the art. For example, one technique for changing isomer content is to add monomeric MDI (e.g., 2,4-MDI) to a mixture of MDI containing an amount of polymeric MDI that is higher than desired.

The reaction mixture also includes (iii) a catalyst. According to one embodiment, the catalyst includes a trimerization catalyst. Examples of trimerization catalysts include, but are not limited to, tris(dialkylaminoalkyl)-s-hexahydrotriazines, such as 1,3,5-tris(N,N-dimethylaminopropyl)-s-hexahydrotriazine, potassium salts of carboxylic acids (for e.g., potassium acetate, potassium pivlate, potassium octoate, potassium triethylacetate, potassium neoheptanoate, potassium neooctanoate, potassium ethyl hexanoate), tetraalkylammonium hydroxides, such as tetramethylammonium hydroxide, alkali metal hydroxides such as sodium hydroxide, alkali metal alkoxides such as sodium methoxide and potassium isopropoxide, alkali metal salts of long-chain fatty acids having 10 to 20 carbon atoms and, in some embodiments, pendant hydroxyl groups, quaternary ammonium carboxylates (for e.g., (2-hydroxypropyl)trimethylammonium 2-ethylhexanoate (“TMR”), (2-hydroxypropyl)trimethylammonium formate (“TMR-2”), tetramethylammonium pivalate, tetramethylammonium triethylacetae) and combinations thereof.

The trimerization catalyst may also include a trimerization catalyst compound selected from one or more organic metal salts, preferably alkali or earth alkali metal salts, and one or more compounds selected from compounds which comprise a carboxamide group having the structure —CO—NH₂ and/or from compounds which comprise a group having the structure —CO—NH—CO— which are described in EP2830761B1, paragraphs [0039]-[0052], the contents of which is incorporated herein by reference.

The amount of trimerization catalyst present in the reaction mixture may be within a range of about 0.01-5% by weight based on the weight of (i) the polyol and (ii) the polyisocyanate, or in some embodiments about 0.05-3% by weight, based on the total weight of (i) the polyol and (ii) the polyisocyanate.

The catalyst may also include an amine catalyst compound comprising at least one tertiary amine group, a non-amine catalyst compound or a mixture thereof.

Examples of amine catalyst compounds comprising at least one tertiary group include, but are not limited to, bis-(2-dimethylaminoethyl)ether (e.g., JEFFCAT® ZF-20 catalyst), N,N,N′-trimethyl-N′-hydroxyethylbisaminoethyl ether (e.g., JEFFCAT® ZF-10 catalyst), N-(3-dimethylaminopropyl)-N,N-diisopropanolamine (e.g., JEFFCAT® DPA catalyst), N,N-dimethylethanolamine (e.g., JEFFCAT® DMEA catalyst), blends of N,N-dimethylethanolamine and ethylene diamine (e.g., JEFFCAT® TD-20 catalyst), N,N-dimethylcyclohexylamine (e.g., JEFFCAT® DMCHA catalyst), N-methyldicyclohexylamine (e.g., POLYCAT® 12 catalyst), benzyldimethylamine (e.g., JEFFCAT® BDMA catalyst), diethyltoluenediamine, pentamethyldiethylenetriamine (e.g., JEFFCAT® PMDETA catalyst), N,N,N′,N″,N″-pentamethyldipropylenetriamine (e.g., JEFFCAT® ZR-40 catalyst), N,N-bis(3-dimethylaminopropyl)-N-isopropanolamine (e.g., JEFFCAT® ZR-50 catalyst), N′-(3-(dimethylamino)propyl-N,N-dimethyl-1,3-propanediamine (e.g., JEFFCAT® Z-130 catalyst), 2-(2-dimethylaminoethoxy)ethanol (e.g., JEFFCATR ZR-70 catalyst), N,N,N′-trimethylaminoethyl-ethanolamine (e.g., JEFFCAT® Z-110 catalyst), N-ethylmorpholine (e.g., JEFFCAT® NEM catalyst), N-methylmorpholine (e.g., JEFFCAT® NMM catalyst), 4-methoxyethylmorpholine, N,N′dimethylpiperzine (e.g., JEFFCAT® DMP catalyst), 2,2′dimorpholinodiethylether (e.g., JEFFCAT® DMDEE catalyst), 1,3,5-tris(3-(dimethylamino)propyl)-hexahydro-s-triazine (e.g., JEFFCAT® TR-90 catalyst), 1-propanamine, 3-(2-(dimethylamino)ethoxy), substituted imidazoles (e.g., 1-methylimidazole, 1,2-dimethlyimidazol (e.g., DABCO® 2040 catalyst and TOYOCAT® DM70 catalyst), 1-methyl-2-hydroxyethylimidazole, N-(3-aminopropyl)imidazole, 1-n-butyl-2-methylimidazole, 1-iso-butyl-2-methylimidazole, N,N′-dimethylpiperazine, bis-substituted piperazines (e.g., aminoethylpiperazine, N,N′,N′-trimethyl aminoethylpiperazine or bis-(N-methyl piperazine)urea), N-methylpyrrolidines and substituted methylpyrrolidines (e.g., 2-aminoethyl-N-methylpyrrolidine or bis-(N-methylpyrrolidine)ethyl urea), 3-dimethylaminopropylamine, N,N,N″,N″-tetramethyldipropylenetriamine, tetramethylguanidine, and 1,2-bis-diisopropanol. Other examples of amine catalysts include N-butylmorpholine, dimorpholinodiethylether, N,N′-dimethylaminoethanol, N,N-dimethylamino ethoxyethanol, bis-(dimethylaminopropyl)-amino-2-propanol, bis-(dimethylamino)-2-propanol, bis-(N,N-dimethylamino)ethylether, N,N,N′-trimethyl-N′hydroxyethyl-bis-(aminoethyl)ether, N,N-dimethylamino ethyl-N-methyl amino ethanol, tetramethyliminobispropylamine, N,N-dimethyl-p-toluidine, diethyltoluenediamine, 3,5-dimethylthio-2,4-toluenediamine; poly(oxypropylene)triamine (JEFFAMINE® T-5000 amine), reactive acid blocked catalysts (for e.g., phenolic acid salt of 1,8-diazabicyclo(5,4,0)undecene-7) and combinations thereof.

The non-amine catalyst compound includes organo-metallic compounds (e.g., organic salts of transition metals such as titanium, iron, nickel), post-transition metals (e.g., zinc, tin, and bismuth), alkali metals (e.g., lithium, sodium, and potassium), alkaline earth metals (e.g., magnesium and calcium), or combinations thereof. Other suitable non-amine catalyst compounds include ferric chloride, ferric acetylacetonate, zinc salts of carboxylic acids, zinc 2-ethylhexanoate, stannous chloride, stannic chloride, tin salts of carboxylic acids, dialkyl tin salts of carboxylic acids, tin (II) 2-ethylhexanoate, dibutyltin dilaurate, dimethyltin dimercaptide, bismuth (III) carboxylate salts (e.g., bismuth(2-ethylhexanote)), bismuth neodecanoate, bismuth pivalate, bismuth-based catalysts, 1,1′,1″,1′″-(1,2-ethanediyldinitrilo)tetrakis[2-propanol] neodecanoate complexes, 2,2′,2″,2′″-(1,2-ethanediyldinitrilo)tetrakis[ethanol] neodecanoate complexes, K-KAT XC-C₂₂₇ bismuth salt (available from King Industries), sodium acetate, sodium N-(2-hydroxy-5-nonylphenol)methyl-N-methylglycinate (JEFFCAT® TR52), bismuth(2-ethylhexanote), and combinations thereof.

The amount of the amine and non-amine catalyst compounds present in the reaction mixture may be within a range of about 0.01-4% by weight, or about 0.2-3.7% by weight or about 0.5-3.5% by weight, based on the total weight of (i) the polyol and (ii) the polyisocyanate.

The reaction mixture also includes (iv) a blowing agent. In one embodiment, the blowing agent includes water. For purposes of this disclosure water shall be considered a distinct component from component (i). In other words, the reaction mixture disclosed herein comprises not only component (i) but water as well.

Any type of water may be used including purified water which has been filtered or processed to remove impurities. Other suitable types of water include distilled water and water that has been purified via one or more of the following processes: capacitive deionization, reverse osmosis, carbon filtering, microfiltration, ultrafiltration, ultraviolet oxidation, and/or electrodeionization.

The amount of blowing agent present in the reaction mixture may be in a range of about 0.1-2.5% by weight or about 0.2-1.5% by weight, based on the total weight of (i) the polyol.

The reaction mixture may also optionally include (v) at least one chain extender or crosslinking agent. Chain extenders are generally grouped as having a functionality equal to 2 and include diols, diamines, and combinations thereof. The chain extender may have a molecular weight of up to about 500 Daltons or up to about 300 Daltons, such as at least about 35-500 Daltons.

One or more short chain polyols having from 2 to 20, or 2 to 12, or 2 to 10 or 2 to 8 carbon atoms may be used as chain extenders in the reaction system to increase the molecular weight of the thermoplastic polyurethane. Examples of chain extenders include, but are not limited to, lower aliphatic polyols and short chain aromatic glycols having molecular weights of less than 500 Daltons or less than 300 Daltons. Suitable chain extenders include organic diols (including glycols) having a total of from 2 to about 20 carbon atoms such as alkane diols, cycloaliphatic diols, alkylaryl diols, and the like. Exemplary alkane diols include ethylene glycol, diethylene glycol, 1,3-propanediol, 1,3-butanediol, 1,4-butanediol, (BDO), 1,5-pentanediol, 2,2-dimethyl-1,3-propanediol, propylene glycol, dipropylene glycol, 1,6-hexanediol, 1,7-heptanediol, 1,9-nonanediol, 1,10-decanediol, 1,12-dodecanediol, tripropylene glycol, triethylene glycol, and 3-methyl-1,5-pentanediol. Examples of suitable cycloaliphatic diols include 1,2-cyclopentanediol, and 1,4-cyclohexanedimethanol (CHDM). Examples of suitable aryl and alkylaryl diols include hydroquinone di(1,3-hydroxyethyl)ether (HQEE), 1,2-dihydroxybenzene, 1,3-dihydroxybenzene, 1,4-dihydroxybenzene, 1,2,3-trihydroxybenzene, 1,2-di(hydroxymethyl)benzene, 1,4-di(hydroxymethyl)benzene, 1,3-di(2-hydroxyethyl)benzene, 1,2-di(2-hydroxyethoxy)benzene, 1,4di-(2-hydroxyethoxy)benzene, bisethoxy biphenol, 2,2-di(4-hydroxyphenyl)propane (i.e., bisphenol A), bisphenol A ethoxylates, bisphenol F ethoxylates, 4,4-isopropylidenediphenol, 2,2-di[4-(2-hydroxyethoxy)phenyl]propane (HEPP), and mixtures thereof. In another embodiment, the chain extender is a sucrose-based polyol, such as sorbitol.

In another embodiment, the chain extender comprises a hydroxy-carboxylic acid having the general formula (HO)ₓQ(COOH)_{y}, wherein Q is a straight or branched hydrocarbon radical containing 1 to 12 carbon atoms, and x and y are each integers from 1 to 3. In certain embodiments, the chain extender comprises a diol carboxylic acid. In other embodiments, the chain extender comprises a bis(hydroxylalkyl) alkanoic acid. In certain embodiments, the chain extender comprises a bis(hydroxylmethyl) alkanoic acid. In certain embodiments the diol carboxylic acid is selected from the group consisting of 2,2 bis-(hydroxymethyl)-propanoic acid (dimethylolpropionic acid, DMPA) 2,2-bis(hydroxymethyl) butanoic acid (dimethylolbutanoic acid; DMBA), dihydroxysuccinic acid (tartaric acid), and 4,4′-bis(hydroxyphenyl) valeric acid. In certain embodiments, the chain extender comprises an N,N-bis(2-hydroxyalkyl)carboxylic acid

The crosslinking agents are generally grouped as having a functionality equal to 3 or more. They also are usually represented by relatively short chain or low molecular weight molecules such as glycerine, ethanolamine, diethanolamine, trimethylolpropane (TMP), 1,2,6-hexanetriol, triethanol-amine, pentaerythritol, N,N,N′,N′-tetrakis(2-hydroxypropyl)-ethylenediamine, diethyl-toluenediamine, dimethylthiotoluenediamine, and combinations thereof.

In one embodiment, the amount of (v) the chain extender or crosslinking agent or mixture thereof present in the reaction mixture may be in range of about 0.1-15% by weight, based on the total weight of (i) the polyol. In another embodiment, the amount of the chain extender or the crosslinking agent or mixture thereof present in the reaction mixture may be in a range of about 0.5-12% by weight or about 1-10% by weight, based on the total weight of (i) the polyol.

The reaction system may also optionally include (vi) one or more known additives, including, but not limited to, surfactants, silane adhesion promoters, antioxidants, waxes, colorants, flame retardants, microbial inhibitors, fillers, mould release agents, viscosity reducers; carbon black, titanium dioxide, and metal flake infra-red opacifiers, inert and insoluble fluorinated compounds, and perfluorinated cell-size reducing compounds, calcium carbonate fillers, glass fibers and/or ground up foam waste reinforcing agents; zinc stearate, butylated hydroxy toluene antioxidants, dyestuffs and pigments.

In certain embodiments, the surfactants can comprise one or more silicone or non-silicone-based surfactants. Suitable silicone surfactants that can be disclosed herein include polyorganosiloxane polyether copolymers and polysiloxane polyoxyalkylene block co-polymers.

Non-silicone surfactants that can be used in the polyurethane insulation foam composition disclosed herein include non-ionic, anionic, cationic, ampholytic, semi-polar, zwitterionic organic surfactants. Suitable non-ionic surfactants include phenol alkoxylates and alkylphenol alkoxylates (e.g., ethoxylated phenol and ethoxylated nonylphenol, respectively).

When present, these additional additives may be used in an amount of about 0.01-15% by weight, or about 0.1-10% by weight, or about 0.5-5% by weight, based on the total weight of the reaction mixture. These ranges may apply separately to each additional additive present in the reaction mixture or to the total of all additional additives present.

In some embodiments, the reaction mixture may have a hydroxyl value in a range of about 150-700 mg KOH/g or about 200-600 mg KOH/g o about 350-500 mg KOH/g. In another embodiment, the reaction mixture may have an isocyanate index of greater than about 201 or greater than about 203 or greater than about 205 or greater than about 207 or greater than about 210. In other embodiments, the reaction mixture may have an isocyanate index of less than about 10,000 or less than about 1000 or less than about 500. In still other embodiments, the reaction mixture may have an isocyanate index within a range of greater than about 200 and less than about 500 or about 201-350.

According to another embodiment, there is provided a process for the production of a polyurethane/polyisocyanurate molded article, including the steps of:
a) applying a first fiber material having a first surface and a second surface to a first surface of a core material;
b) applying a second fiber material having a first surface and a second surface to a second surface of the core material forming a sandwich structure having a first and a second surface wherein the first and second fiber material may be the same of different;
c) applying the reaction mixture of the present disclosure to the first and the second surface of the sandwich structure forming a reaction mixture coated sandwich structure;
d) placing the reaction mixture coated sandwich structure into a mold;
e) shaping the reaction mixture coated sandwich structure in the mold at a temperature between about 100° C. and about 200° C. while curing the reaction mixture to form the polyurethane/polyisocyanurate molded article;
f) removing the polyurethane/polyisocyanurate molded article from the mold; and
e) optionally, post-treating the polyurethane/polyisocyanurate molded article.

According to steps a) and b), the first and second fiber materials are applied to the first and second surfaces of the core material to form a sandwich structure having first and second surfaces. The first and second fiber material may be the same or different and may include woven fiber mats, non-woven fiber mats, continuous strand fiber, fiber random structures, fiber tissues, chopped fibers, ground fibers, knitted fabrics, reinforced fiber mats or any combination thereof. Preferred fibers are carbon fibers, polymeric fibers, for example KEVLAR™ fibers or aramide fibers, mineral fibers, glass fibers, natural fibers such as Kenaf, Hemp, coconut, and mixtures thereof. In one embodiment, the fiber material is a glass fiber mat, a glass fiber nonwoven, a random-laid glass fiber, a woven glass fiber fabric, or chopped or ground glass.

The core material may include a honeycomb paperboard, a plastic honeycomb, aluminum honeycomb, balsa wood, a rigid foam, compressed or uncompressed cotton fibers, compressed or uncompressed natural fibers, or compressed or uncompressed plastic fibers such as polyethylene terephthalate (PET).

The reaction mixture is then applied to the first and second surfaces of the sandwich structure to form the reaction mixture coated sandwich structure and then placed into a mold in steps c) and d). At the same time that the reaction mixture is applied, chopped fibers may optionally be applied over the whole or part of one or both surfaces of the sandwich structure. For example, when a reinforced fiber mat is used in steps a) and/or b), the mat may be first taken and impregnated in a conventional way with the reaction mixture and then one or more types of chopped fibers may additionally be applied at the same time over the whole or part of the surface(s). Bonding of these additionally applied, chopped fibers wetted with the reaction mixture takes place. Application of the reaction mixture to the fiber material can be affected by customary methods, such as spray application, knife-coating or roll application. The application can be affected at temperatures of, for example 20° C. to 50° C., preferably at elevated temperatures of 23° C. to 45° C. The amount applied can vary within ranges, such as within a range from 150 g/m² to 5000 g/m², particularly preferably from 200 g/m² to 2000 g/m², more preferably 400 g/m² to 1000 g/m² and especially 425 g/m² to 500 g/m². This produces a reaction mixture coated sandwich structure having a core material and two fiber materials comprising the reaction mixture which is then placed within into the mold.

The reaction mixture coated sandwich structure is then shaped and cured within the mold. The mold temperature may be within a range of about 0°−180° C. or about 100°-160° C., or about 130°-150° C. The core material and fiber materials may be optionally pressed together with one or more of an outer layer or a decorative layer. The outer layer or the decorative layer can in this case be applied to one or both sides of the reaction mixture coated sandwich structure or they may be placed into the mold. As an alternative, the outer layer or the decorative layer can be applied in a further work step after the polyurethane/polyisocyanurate molded article has been demolded.

Decorative materials may, in this connection, be carpets, textiles blocked against impregnation with polyurethane, compact or foamed plastics films, as well as spray skins or RIM skins of polyurethane. As outer layers there may also be used preformed materials suitable for external applications, such as metal foils or sheets (for e.g. aluminum or steel), as well as compact thermoplastic composites of PMMA (polymethyl methacrylate), ASA (acrylic ester-modified styrene-acrylonitrile terpolymer), PC (polycarbonate), PA (polyamide), PBT (polybutylene terephthalate) and/or PPO (polyphenylene oxide) in painted, paintable prepared or colored form, a glass-reinforced composite sheet (e.g. sheet molding compound, polyurethane), an in-mold coating and combinations thereof. As outer layers there may likewise be used continuously or batchwise-produced outer layers based on melamine-phenol, phenol-formaldehyde, epoxy, or unsaturated polyester resins.

During the pressing, the core material is compressed at least in regions of the core material. The compression can be varied over a broad range and can range from a few tens of millimeters to a compression of less than 10% of the starting thickness of the core material. When pressing the reaction mixture sandwich structure, the core material is preferably compressed to different degrees in different regions. Alternatively, the reaction mixture can be applied to the first or second or both fiber materials on one side or on both sides. Subsequently, the fiber material comprising the reaction mixture is applied onto the core material.

In an alternative embodiment to the embodiment above, there is provided a process for the production of a polyurethane/polyisocyanurate molded article, including the steps of:
a) positioning a substrate, such as a textile or carpet, in a mould,
b) applying the reaction mixture of the present disclosure to a surface of the substrate;
c) applying a first fiber material having a first surface and a second surface to a first surface of a core material;
d) applying a second fiber material having a first surface and a second surface to a second surface of the core material forming a sandwich structure having a first and a second surface wherein the first and second fiber material may be the same of different;
e) positioning the sandwich structure in the mould so that the first surface of the sandwich structure is adjacent to the reaction mixture;
f) applying the reaction mixture of the present disclosure by spray application to the second surface of the sandwich structure forming a reaction mixture coated sandwich structure;
g) shaping the reaction mixture coated sandwich structure in the mold at a temperature between about 100° C. and about 200° C. while curing the reaction mixture to form the polyurethane/polyisocyanurate molded article;
f) removing the polyurethane/polyisocyanurate molded article from the mold; and
e) optionally, post-treating the polyurethane/polyisocyanurate molded article.

In some embodiments, the sandwich structure may be preformed and therefore steps c) and d) may be deleted and steps e) and f) may be replaced with:
e) positioning a preformed sandwich structure in the mould so that the first surface of the preformed sandwich structure is adjacent to the reaction mixture;
f) applying the reaction mixture of the present disclosure by spray application to the second surface of the preformed sandwich structure forming a reaction mixture coated sandwich structure;
In some embodiments, the substrate may also be a metal foil, a metal sheet, a thermoplastic composite of polymethyl methacrylate, acrylic ester-modified styrene-acrylonitrile terpolymer, polycarbonate, polyamide, polybutylene terephthalate, and/or polyphenylene oxide in painted, paintable prepared or colored form, a glass-reinforced composite sheet, an in-mold coating, and combinations thereof.

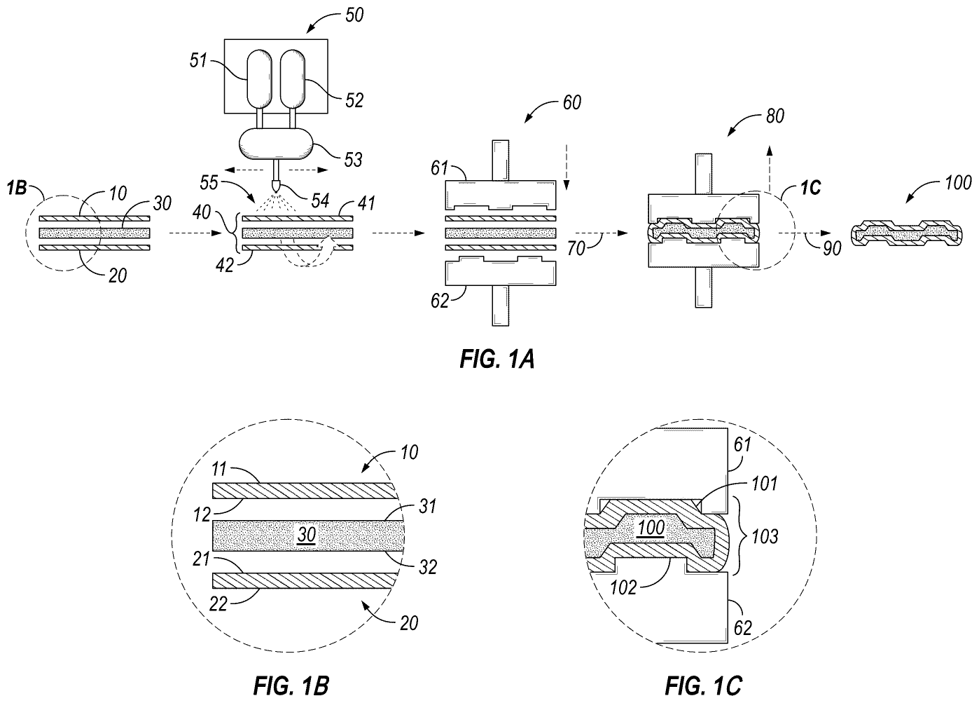

Now referring to FIGS. 1A-1C, the process of the present disclosure includes the step of first applying a first fiber material 10, having a first surface 11 and a second surface 12, to a first surface 31 of a core material 30. Concurrently or sequentially, a second fiber material 20, having a first surface 21 and a second surface 22, is applied to a second surface 32 of the core material 30 forming a sandwich structure 40 having a first 41 and a second surface 42 where the first fiber material 10 and second fiber material 20 may be the same of different. A low pressure or high-pressure dispensing machine 50 may be used to spray the reaction mixture of the present disclosure from a mixture head 53. The mixture head 53 is fed from an A side tank 51 comprising the polyisocyanate and a B side tank 52 comprising the polyol. Components (iii), (iv), (v), and (vi) of the reaction mixture may individually be included in either the A-side tank or B-side tank. The contents of the A side and B side tanks are mixed in the mixing head 53 and the spray applied through a spray nozzle 54 to each side 41 and 42 of the sandwich structure 40. The reaction mixture from the mixing head 53 may be applied to the sandwich structure 40 in a vertical position (not shown in FIGS. 1A-1C) or preferably a horizontal position, as shown in FIG. 1A. The reaction mixture 55 is applied the surface 41 and a to first second surface 42 of the sandwich structure 40. Preferably the (clamped) sandwich structure which can be moved, preferably by robotics, in both the X and Y axis directions (length and width) beneath the dispensing machine such that an evenly distributed coating may be applied to the entire surface of the sandwich structure 40. Preferably, the sandwich structure 40 is rotated, preferably clamped, and robotically rotated so that each side 41 and 42 may be sprayed 55.

The sandwich structure 40 is then coated with the reaction mixture and placed in a mold 60 having a mold cavity defined by an upper mold half 61 and a lower mold half 62, (or alternatively the sandwich structure 40 is placed in the mold 60 and coated with the reaction mixture), the mold 60 being capable of shaping the reaction mixture coated sandwich structure 40 to the desired molded article shape. Preferably, the mold 60 is temperature controlled. The mold is closed 70 and the reaction mixture coated sandwich structure is shaped during the molding and curing step 80. Preferably, the mold temperature is within a range of about 100° C. and about 160° C. or about 130° C. and about 150° C. While the mold is closed and while shaping is occurring/has occurred, the reaction mixture is allowed to cure 80 forming a molded polyurethane/polyisocyanurate-coated sandwich structure or a molded polyurethane article 100. The mold 60 is opened and the molded polyurethane article 100 is removed 90 from the mold 50. Optionally, the molded polyurethane article may be post-treated by one or more treatments, for example, carpet may be applied, it may be painted, a decorative skin may be applied, it may be trimmed to a desired shape, and the like. In some embodiments, one or more outer layers or decorative materials may be applied to the reaction mixture coated sandwich structure before the mold 60 is closed and the reaction mixture is cured.

In one embodiment, the mold 60 is designed such that when the reaction mixture coated sandwich structure is shaped, part or all of the periphery of the final molded article is shaped such that the inner core material is not visible or exposed. In other words, the cured polyurethane/polyisocyanurate coated fiber surfaces 101 and 102 cover or hide the core material and/or are in contact with each other 103, as shown in FIG. 1B.

The polyurethane/polyisocyanurate sandwich panels produced by the process according to the present disclosure may, for example, be used as structural components or trim parts, especially in the automobile industry, the furniture industry, or the construction industry.

The molded articles produced in accordance with the present disclosure may be used as structural parts or lining/cladding parts, in particular for the automobile industry, for example a load floor, lower sound shield, acoustical belly pan, aero shield, splash shield, underbody panel, chassis shield, door module, rear package, leaf spring, roof, or hood, in the furniture industry and building and construction industry, such as door or window frames and facades.

The following examples are provided to illustrate the present disclosure but are not intended to limit the scope thereof.

### EXAMPLES

### Honeycomb Sandwich Panels Produced Using Various Reaction Mixtures

Honeycomb cores (6 mm cell size) were covered with 450 g/m² random chopped glass mat on both sides. The raw sandwich structure was sprayed with the reaction mixtures shown in Table 1 below at 450 g/m² followed by a 450 g/m² perimeter spray. The coated sandwich structure was then placed in a mold 60 seconds, cured and demolded. Each mold part was then exposed to a temperature approaching 210° C. for a minimum of 30 minutes and the molded part was examined to determine whether defects were present on the molded part.

TABLE 1

| | Comp 1 | Ex 1 | Ex 2 | Ex 3 | Ex 4 | Ex 5 | Ex 6 |
|---|---|---|---|---|---|---|---|
| | (grams) | (grams) | (grams) | (grams) | (grams) | (grams) | (grams) |
| B side | | | | | | | |
| Polyol 1* | 69.9 | 69.9 | 69.9 | 30.8 | 30.8 | 30.8 | 30.8 |
| Polyol 2* | 30 | 30 | 30 | 59 | 59 | 59 | 59 |
| Crosslinking | | | | 10 | 10 | 10 | 10 |
| Agent* | | | | | | | |
| Catalyst 1* | 4.25 | 4.25 | 4.25 | 4.25 | 4.25 | 4.25 | 4.9 |
| Catalyst 2* | 0.5 | 0.5 | 0.5 | 0.25 | 0.25 | 0.25 | 0.27 |
| Catalyst 3* | 1.45 | 1.45 | 1.45 | 1.28 | 1.28 | 1.28 | 1.33 |
| Pigment | 10 | 10 | 10 | 10 | 10 | 10 | 10.5 |
| Surfactant | 3 | 3 | 3 | 3 | 3 | 3 | 3 |
| Mold Release | 10 | 10 | 10 | 10 | 10 | 10 | 10.5 |
| Agent | | | | | | | |
| Phthalic | 0.1 | 0.1 | 0.1 | 0.25 | 0.25 | 0.25 | 0.25 |
| Anhydride | | | | | | | |
| Water | 0.25 | 0.25 | 0.25 | 0.25 | 0.25 | 0.25 | 0.25 |
| Hydroxyl | 452.9 | 452.9 | 452.9 | 451.4 | 451.4 | 451.4 | 449 |
| Value | | | | | | | |
| A Side | | | | | | | |
| Polyisocyanate | | | | | | | |
| Index | 205 | 255 | 305 | 205 | 255 | 305 | 255 |
| A/B ratio | 2.833 | 3.524 | 4.215 | 2.829 | 3.519 | 4.209 | 2.907 |
| Glass | 191 | 210 | 222 | 192 | 210 | 222 | |
| Transition | | | | | | | |
| Temp DMG′ | | | | | | | |
| on-set | | | | | | | |
| MW between | 328 | 287 | 263 | 329 | 287 | 263 | 248 |
| cross-links | | | | | | | |

Polyol 1—PO-based polyol, hydroxyl value 650
Polyol 2—PO based polyol, hydroxyl value 240
Crosslinking agent—Glycerine.
Catalyst 1—Diethyl toluenediamine
Catalyst 2—Acid blocked tertiary amine
Catalyst 3—Potassium-octoate in diethylene glycol

Comp 1 was a comparative reaction mixture formulated to have a 205 index and this reaction mixture used to produce a molded part at mold temperatures of 130° C., 140° C. and 150° C. After these molded parts were exposed to a temperature of 210° C. for the time period discussed above, severe blistering and defects were apparent on each of their surfaces.

Ex 1 and Ex 2 were extensions of Comp 1 and were formulated to have increased indices of 255 and 305, respectively. Defects were still apparent on both Ex 1 and Ex 2 parts molded at a mold temperature of 130° C. and then exposed to the temperature of 210° C. However, when the mold temperature was increased to 140° C. and 150° C., no defects were found on the molded parts after exposure to the temperature of 210° C.

Ex's 3-5 reflected a change in formulation by the introduction of a crosslinking agent while maintaining the same hydroxyl value for the B side. For Ex 3, defects were observed on the parts molded at mold temperatures of 130° C. and 140° C. after exposure to a temperature of 210° C., but defects were not observed on parts molded at a mold temperature of 150° C. after exposure to a temperature of 210° C. Similar observations were observed with Ex 4. Surprisingly, no defects were observed on the Ex 5 part molded at mold temperatures of 130° C., 140° C. or 150° C. after exposure to a temperature of 210° C. Note, the molecular weight between crosslinks (Mc) and glass transition temperature by DMA G′ onset were similar for the two B-side variations (Comp1/Ex1/Ex2 vs. Ex3/Ex4/Ex5), which may suggest that the crosslinking agent played a role beyond crosslink density to improve thermal stability.

In Ex 6, the A-side isocyanate was switched from a 4,4′-MIDI based prepolymer to a uretonomine-modified 4,4′-diphenylmethane diisocyanate. The part molded at a temperature of 140° C. did not exhibit any defects after exposure to a temperature of 210° C.

TABLE 2

| | Mold Temperature (° C.) | | | | | | |
|---|---|---|---|---|---|---|---|
| | Comp 1 | Ex 1 | Ex 2 | Ex 3 | Ex 4 | Ex 5 | Ex 6 |
| Index | 205 | 255 | 305 | 205 | 255 | 305 | 255 |
| Defects | | | | | | | |
| Observed at | | | | | | | |
| 130 | Yes | Yes | Yes | Yes | Yes | No | |
| 140 | Yes | No | No | Yes | No | No | No |
| 150 | Yes | No | No | No | No | No | |

While the foregoing is directed to embodiments of the present disclosure, other and further embodiments of the disclosure may be devised without departing from the basic scope thereof, and the scope thereof is determined by the claims that follow.

1. A reaction mixture for use in the production of polyurethane/polyisocyanurate sandwich panels which exhibit high temperature stability, the reaction mixture comprising: (i) a polyol; (ii) a polyisocyanate; (iii) a catalyst, (iv) a blowing agent; and optionally (v) at least one chain extender or crosslinking agent and optionally (vi) an additive and where the reaction mixture has an isocyanate index greater than 200.

2. The reaction mixture of claim 1, wherein the polyol comprises a polyether polyol.

3. The reaction mixture of claim 2, wherein the polyether polyol is a pol(oxypropylene) diol or triol obtained by the addition of propylene oxide to a di- or trifunctional initiator.

4. The reaction mixture of claim 1, wherein the polyisocyanate is selected from (1) a diphenylmethane diisocyanate comprising at least 40% by weight, based on the total weight of the diphenylmethane diisocyanate of 4,4′-diphenylmethane diisocyanate (4,4′-MDI); (2) a carbodiimide and/or uretonimine modified variant of diphenylmethane diisocyanate (1) having an NCO value of 20% by weight or more; and (3) a mixture thereof.

5. The reaction mixture of claim 1, wherein the catalyst comprises a trimerization catalyst.

6. The reaction mixture of claim 1, wherein the chain extender or crosslinking agent comprises ethylene glycol, diethylene glycol, 1,3-propanediol, 1,3-butanediol, 1,4-butanediol, (BDO), 1,5-pentanediol, 2,2-dimethyl-1,3-propanediol, propylene glycol, dipropylene glycol, 1,6-hexanediol, 1,7-heptanediol, 1,9-nonanediol, 1,10-decanediol, 1,12-dodecanediol, tripropylene glycol, triethylene glycol, or 3-methyl-1,5-pentanediol, glycerine, sorbitol or a mixture thereof.

7. The reaction mixture of claim 1, wherein the one or more additives comprises a surfactant.

8. A process for the production of a polyurethane/polyisocyanurate molded article which exhibits high temperature stability, comprising the steps of:
a) applying a first fiber material having a first surface and a second surface to a first surface of a core material;
b) applying a second fiber material having a first surface and a second surface to a second surface of the core material forming a sandwich structure having a first and a second surface wherein the first and second fiber material may be the same of different;
c) applying the reaction mixture of claim 1 to the first and the second surface of the sandwich structure forming a reaction mixture coated sandwich structure;
d) placing the reaction mixture coated sandwich structure into a mold;
e) shaping the reaction mixture coated sandwich structure in the mold at a temperature within a range of about 100° C. and about 160° C. while curing the reaction mixture to form the polyurethane/polyisocyanurate molded article;
f) removing the polyurethane/polyisocyanurate molded article from the mold; and
e) optionally, post-treating the polyurethane/polyisocyanurate molded article.

9. The process of claim 8, wherein e) the shaping the reaction mixture coated sandwich structure in the mold occurs at a temperature within a range of about 130° C. and about 150° C.

10. The process of claim 8, wherein the first fiber material and the second fiber material individually comprise a woven fiber mat, a non-woven fiber mat, a continuous strand fiber, a fiber random structure, a fiber tissue, chopped fibers, ground fibers, knitted fabrics, a reinforced fiber mat or any combination thereof.

11. The process of claim 8, wherein the core material comprises include a honeycomb paperboard, a plastic honeycomb, aluminum honeycomb, balsa wood, a rigid foam, compressed or uncompressed cotton fibers, compressed or uncompressed natural fibers, or compressed or uncompressed plastic fibers.

12. The process of claim 8, wherein the reaction mixture coated sandwich structure is pressed together with one or more of an outer layer or a decorative layer.

13. The process of claim 12, wherein the outer layer comprises a metal foil, a metal sheet, a thermoplastic composite of polymethyl methacrylate, acrylic ester-modified styrene-acrylonitrile terpolymer, polycarbonate, polyamide, polybutylene terephthalate, and/or polyphenylene oxide in painted, paintable prepared or colored form, a glass-reinforced composite sheet, an in-mold coating, and combinations thereof.

14. A polyurethane/polyisocyanurate molded article produced according to the process of claim 8.

15. The polyurethane/polyisocyanurate molded article of claim 14, wherein the molded article is an automotive structural part.

16. The polyurethane/polyisocyanurate molded article of claim 15, wherein the automotive structural part is a load floor, lower sound shield, acoustical belly pan, aero shield, splash shield, underbody panel, chassis shield, door module, rear package, leaf spring, roof, or hood.

17. A process for the production of a polyurethane/polyisocyanurate molded article comprising the steps of:
a) positioning a substrate in a mould,
b) applying the reaction mixture of claim 1 to a surface of the substrate;
c) applying a first fiber material having a first surface and a second surface to a first surface of a core material;
d) applying a second fiber material having a first surface and a second surface to a second surface of the core material forming a sandwich structure having a first and a second surface wherein the first and second fiber material may be the same of different;
e) positioning the sandwich structure in the mould so that the first surface of the sandwich structure is adjacent to the reaction mixture;
f) applying the reaction mixture of claim 1 by spray application to the second surface of the sandwich structure forming a reaction mixture coated sandwich structure;
g) shaping the reaction mixture coated sandwich structure in the mold at a temperature between about 100° C. and about 200° C. while curing the reaction mixture to form the polyurethane/polyisocyanurate molded article;
f) removing the polyurethane/polyisocyanurate molded article from the mold; and
e) optionally, post-treating the polyurethane/polyisocyanurate molded article.
